(19) United States
(12) Patent Application Publication
(10) Pub. No.: US 2013/0235993 A1
(43) Pub. Date: Sep. 12, 2013

(54) INTEGRATING CALENDARING WITH AD HOC CALL INITIATION

(71) Applicants: Danny S. PAMULA, Fremont, CA (US); Jitendra K. VARSHNEY, Fremont, CA (US)

(72) Inventors: Danny S. PAMULA, Fremont, CA (US); Jitendra K. VARSHNEY, Fremont, CA (US)

(73) Assignee: Cisco Technology, Inc., San Jose, CA (US)

(21) Appl. No.: 13/413,797

(22) Filed: Mar. 7, 2012

(51) Int. Cl. H04M 3/42

(52) U.S. Cl. 379/202.01; 379/207.02

(57) ABSTRACT

In one example, a processing device is configured to transmit a request for an ad hoc call between a caller endpoint and a called endpoint. The processing device is configured to, in response to receiving a busy signal or other offline indication, cause a calendaring application accessible to the caller endpoint to launch.

### TECHNICAL FIELD

The present disclosure relates generally to the field of networking, specifically ad hoc call initiation.

### BACKGROUND

Ad hoc call initiation call flows, especially with a voicemail option, are known. One example of a known ad hoc call initiation call flow with a voicemail option is entitled “draft-jennings-sip-voicemail-uri-06”, and is available on the Internet Engineering Task Force (IETF) website.

In a typical ad hoc call initiation call flow, a first user makes a call to a second user using an endpoint, such as a telephone endpoint. In the case where the callee is offline or ignores/rejects the call request, the caller is presented with a busy tone or other offline indication. The caller may also be presented with the choice of an offline message, e.g. voicemail, if the callee device has the capability. The caller may have to wait for a call back and/or try another ad hoc call to the callee again at a later time.

### BRIEF DESCRIPTION OF THE DRAWINGS

FIG. 1 is a block diagram showing an example system for integrating calendaring with ad hoc call initiation.

FIG. 2 is a flowchart for operating the processing device shown in FIG. 1.

FIG. 3 is a signaling diagram for integrating calendaring with ad hoc call initiation for a Session Initiation Protocol (SIP) endpoint.

FIG. 4 is a flowchart for scheduling an ad hoc call flow

### DESCRIPTION OF EXAMPLE EMBODIMENTS

### Overview

In one example, a processing device is configured to transmit a request for an ad hoc call between a caller endpoint and a called endpoint. The processing device is configured to, in response to receiving a busy signal or other offline indication, cause a calendaring application accessible to the caller endpoint to launch.

### Description

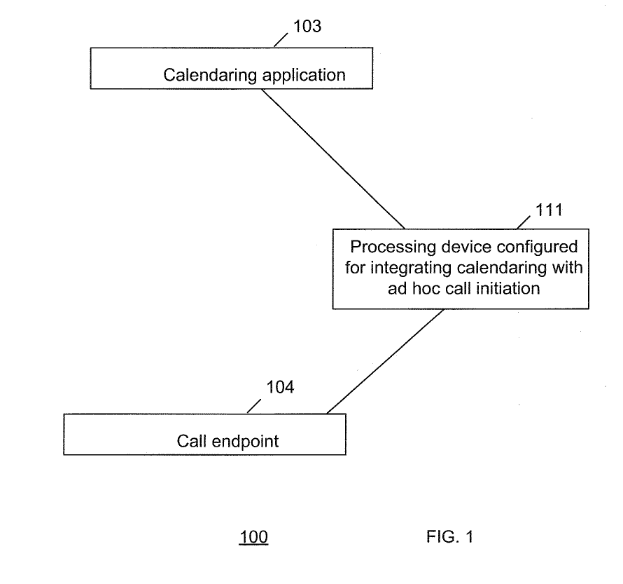

FIG. 1 is a block diagram showing an example system for integrating calendaring with ad hoc call initiation.

The system 100 includes a processing device 111 configured for integrating calendaring with ad hoc call initiation. The processing device 111 may be integrated within an endpoint 104 or its proxy, e.g. a call controller, of the endpoint 104. The endpoint 104 may comprise an IP phone, a smart phone with a calendaring application, a computing device with a chat module (such as a personal computer, a tablet, etc.), a telepresence device, a video conferencing device (dedicated or soft client), or the like, or any combination thereof.

The caller side of an ad hoc call may have access to a calendaring application 103, e.g. an application configured to send a calendar invite according to a predetermined calendaring protocol. In an example, the predetermined calendaring protocol may comprise “iCalendar”, which is described in more detail in Request For Comment (RFC) 2445 (available on the IETF website). In one example, the calendaring application 103 may comprise presently available software for calendaring (e.g. iCal, Microsoft Outlook client, Google Calendar, or the like), or software for calendaring that is yet to be released. The calendaring application 103 may be stored on the caller side, such as on the calling endpoint 104, or on another device associated with the calling endpoint 104 such as but not limited to a local device or a server. As will be discussed later in greater detail, the processing device 111 is configured to cause the calendaring application 103 to launch responsive to receiving a busy signal or other offline indication in an ad hoc call attempt.

The launching of the calendaring application 103 may be subject to acceptance by the caller. For example, the processing device 111 may cause an option to be displayed (visually and/or audibly) on the calling endpoint 104 for scheduling a meeting. In such a case, the launching of the calendaring application 103 by the processing device 111 is responsive to receiving a busy signal or other offline indication in an ad hoc call attempt, but is also responsive to receiving an acceptance by the caller.

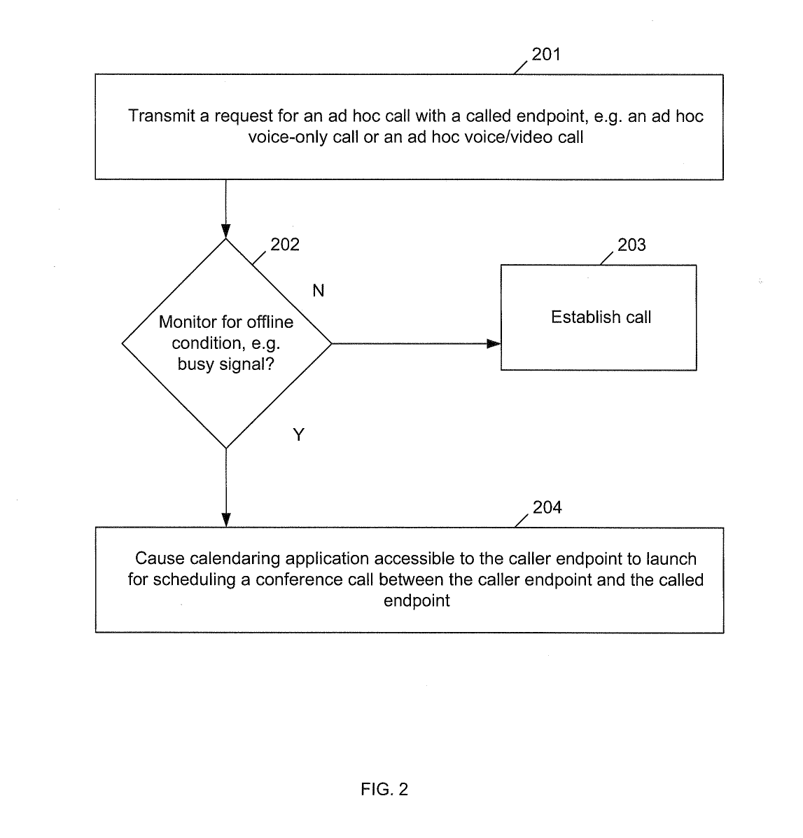

FIG. 2 is a flowchart for operating the processing device shown in FIG. 1.

In block 201, an endpoint of a caller side 101 transmits a request for an ad hoc call with a called endpoint, e.g. an ad hoc voice only call or an ad hoc video/voice call. The endpoint may transmit the call request to a call controller or directly to the called endpoint.

In diamond 202, the processing device 111 monitors for an offline condition, e.g. a busy signal. If no offline condition is detected in diamond 202, then in block 203 the caller endpoint may establish the call with the called endpoint.

If an offline condition is detected in diamond 202, then in block 204 the processing device 111 causes a calendaring application accessible to the caller endpoint to launch for scheduling a conference call between the caller endpoint and the called endpoint.

It should be understood that any of the processes described above may be performed by an endpoint or a proxy, e.g. call controller, of the endpoint. The processes above may be performed exclusively by the endpoint or its proxy, or distributed there between. It should be appreciated that in some examples the processing device 111 performs the operations described above for a call to a called endpoint independently of whether the called side also includes the processing device 111.

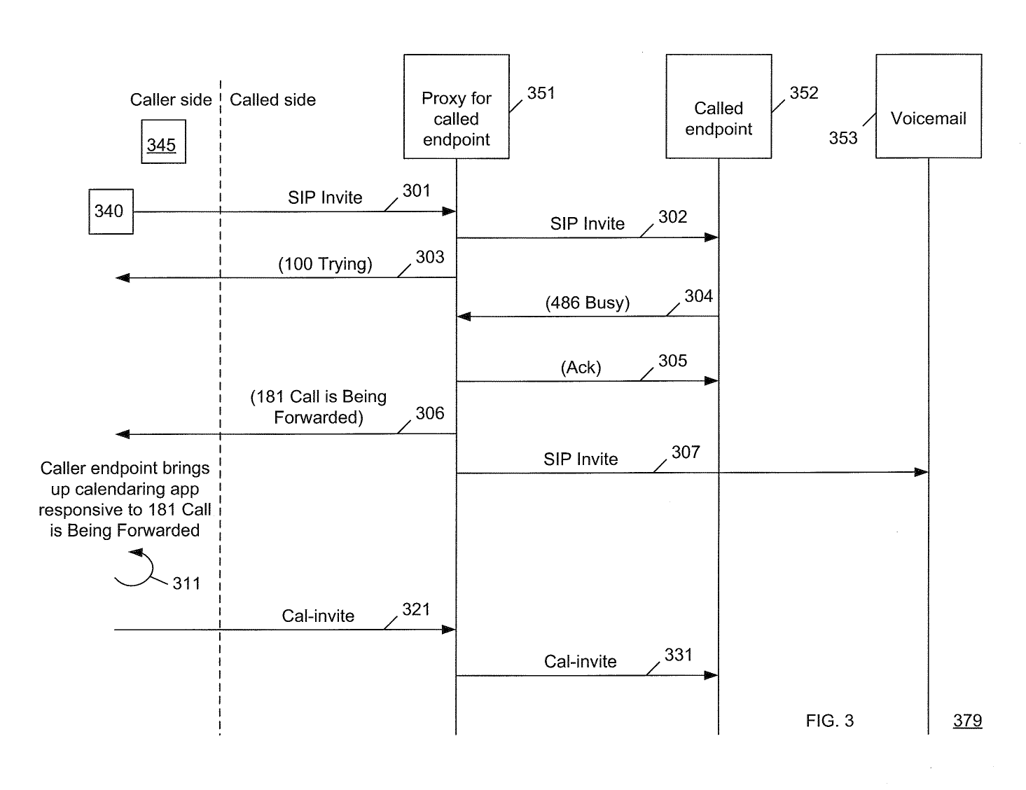

FIG. 3 is a signaling diagram for integrating calendaring with ad hoc call initiation for a Session Initiation Protocol (SIP) endpoint.

In the example call flow 379 shown in FIG. 3, a caller endpoint 340 causes a call request, e.g. SIP invite 301, to be received by a proxy 351 for the called endpoint using the Session Initiation Protocol (SIP). It should be understood that any message to/from the caller side may be transmitted to/from the caller endpoint 340 or a proxy, e.g. a caller controller, thereof. Proxy 351 for the called endpoint in turn transmits a SIP invite 302 to called endpoint 352, and signals the caller side with an acknowledgement 303, e.g. a “100 Trying” message.

In the example, called endpoint 352 does not accept the SIP invite 302. As previously discussed, a callee may be offline or may ignore/reject the call request. For example, called endpoint 352 may transmit an offline indication 304, e.g. a “486 Busy message”, to proxy 351, which proxy 351 may acknowledge 305. Proxy 351 in turn transmits another offline indication 306, e.g. “181 Call is Being Forwarded”, to the caller side. The proxy 351 may also transmit a SIP invite 307 to the voicemail 353 corresponding to the called endpoint 352 to indicate the busy condition.

On the caller side, a processing device 345 operating on either the caller endpoint 340 or a proxy thereof, e.g. call controller, is configured for integrating calendaring with ad hoc call initiation. The processing device 345 is configured to cause a calendaring application accessible to the caller endpoint 340 to launch 311 responsive to receiving an offline indication in an ad hoc call initiation flow. Processing device 345 therefore receives the offline indication 306, and in response, causes caller endpoint 340 to bring up the calendaring application. The launching of the calendaring application may cause a prompt including the graphical user interface of the calendaring application to display on a screen associated with the caller endpoint 340.

In one example, launching the calendaring application comprises causing the caller endpoint 340 to present (via a visual or audio display) an option of scheduling a calendar event in addition to leaving a voicemail. If the caller accepts the option of scheduling the calendar event, then the processing device 345 requests a time. The request may be sent as a Conference Scheduling Protocol (CSP) message.

In one example, processing device 345 may be configured to attempt to retrieve information from a calendaring application associated with the called endpoint 352 before, after, or when requesting the time from the caller. If the called endpoint 352 is online and exposes free/busy information, then processing device 345 may retrieve some or all of the free/busy information and display the retrieved information to the caller in association with requesting the time from the caller.

A caller may then propose a time for a conference call using the launched calendaring application. If the caller does propose a time for a conference call, the caller side transmits a conference invite or other invite generated by the launched calendaring application to the called side. For example, the calendaring application may transmit a conference invite, e.g. cal-invite 321, to the proxy 351. The proxy 351 may in turn transmit a conference invite, e.g. cal-invite 331, to the called endpoint 352. It should be understood that the invitations 321 and 331 may utilize the iCalendar format (referring again to RFC 2445), and may be transmitted via a signaling protocol such as SIP or XMPP.

The called endpoint 352 accesses the cal-invite 331 and presents the same to the callee, who has the option to accept or reject. If accepted, the invite shows on the callee calendar. An accept message (not shown) is sent to the caller side, and a call, such as a conference call, can be established at the time of the schedule meeting according to a conferencing feature of the calendar application(s).

If the callee rejects the invite, a reject message (not shown) is sent back to the caller side. Upon receipt of a reject message, the original caller invite in a calendar operated by the calendaring application of the caller side will be deleted or updated with a reject indication.

It should be appreciated that the processing device 345 is configured to cause a calendaring application accessible to the caller endpoint 340 to launch responsive to receiving an offline indication in an ad hoc call initiation flow. Once the calendar application has launched, the caller may control the launched calendar application, as he desires. For example, the user may desire to propose the aforementioned conference invite, or use any other invitation that may be generated by the launched calendaring application.

In some examples, the called endpoint may be configured to send a “user defined code” 312 to cause the caller endpoint 340 to launch a calendaring application. A value of the “user defined code” 312 is within a range designated for proxies to forward/ignore according to the SIP protocol. The proxy 351 therefore will forward the “user defined code” to the caller side.

The user defined code may be transmitted after any of: transmitting an offline indication (e.g. 486 busy), receiving from proxy 351 an acknowledge corresponding to the offline indication, or receiving a SIP invite to be forwarded to voicemail 353. The user defined code 312 is configured to, when processed, trigger the caller endpoint 340 to launch the calendaring application. The launching of the calendaring application may cause a prompt including the graphical user interface of the calendaring application to display on a screen associated with the caller endpoint 340.

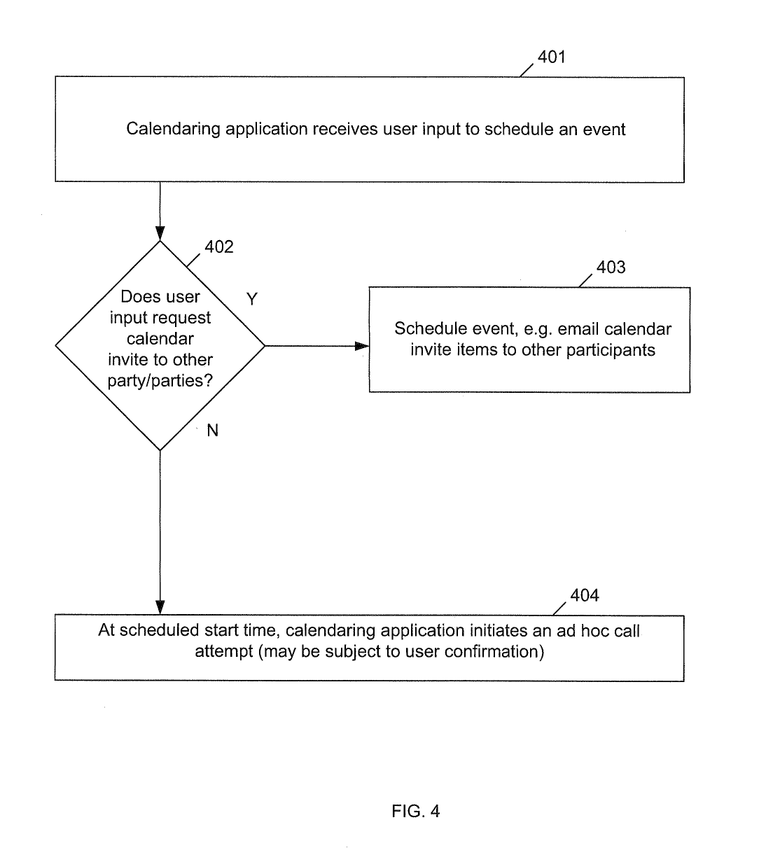

FIG. 4 is a flowchart for scheduling an ad hoc call flow.

In one example, a calendaring application may be configured to schedule an ad hoc call flow as shown in FIG. 4. In block 401, the calendaring application receives a user input to schedule an event. If the user input requests calendar invite(s) to other party/parties, then in block 403 the calendaring application schedules an event, e.g. emails calendar invite items to other participants for the call.

If the user input does not request calendar invite(s) to other party/parties diamond 402, then in block 404 the calendaring application controls an endpoint to initiate an ad hoc call attempt at the scheduled start time of the event. For example, the calendaring application may cause an endpoint or a proxy thereof to initiate an ad hoc call flow at the scheduled start time of the event. Such controlling may be subject to confirmation by the user to be the “caller” for the ad hoc call attempt.

In one application of the above, a user can access a calendaring application to schedule calls where it is not required to notify the callee, but instead initiate an ad hoc call at the scheduled start time. For example, a user may wish to schedule events such as birthdays, anniversaries, or the like, where the callee's calendaring application will not be notified. In such cases, the calendaring application schedules the ad hoc call, but prevents a remote calendaring application for another participant of the scheduled event from discovering the event at least prior to automatically triggering the call. “At least” is emphasized because the remote calendaring application may never discover the event as on the callee side, especially if an incoming ad hoc call is received on the endpoint and answered/accepted by the callee.

In some of the above-described examples, a call may be transmitted using a telephone endpoint. It should be apparent that the principles described above can be applied to any endpoint transmitting a call. For example, a chat client may call a remote endpoint, and in response to an offline condition, be prompted to access a calendaring application.

The system and apparatus described above may use dedicated processor systems, micro controllers, programmable logic devices, microprocessors, or any combination thereof, to perform some or all of the operations described herein. Some of the operations described above may be implemented in software and other operations may be implemented in hardware. Any of the operations, processes, and/or methods described herein may be performed by an apparatus, a device, and/or a system substantially similar to those as described herein and with reference to the illustrated figures.

The processing device may execute instructions or “code” stored in memory. The memory may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory may be “read only” by design (ROM) by virtue of fission settings, or not. Other examples of memory may include, but may not be limited to, WORM, EPROM, EEPROM, FLASH, or the like, which may be implemented in solid state semiconductor devices. Other memories may comprise moving parts, such as a conventional rotating disk drive. All such memories may be “machine-readable” and may be readable by a processing device.

Operating instructions or commands may be implemented or embodied in tangible forms of stored computer software (also known as “computer program” or “code”). Programs, or code, may be stored in a digital memory and may be read by the processing device. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

One of skill in the art will recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

1. An apparatus, comprising:
a processing device configured to:
transmit a request for an ad hoc call between a caller endpoint and a called endpoint;
receive a busy signal or other offline indication; and
cause a calendaring application accessible to the caller endpoint to launch responsive to receiving the busy signal or other offline indication.

2. The apparatus of claim 1, wherein the processing device is configured to:
receive an input after the launch of the calendaring application; and
schedule a conference call using the calendaring application according to the received input, the conference call between the caller endpoint and the called endpoint.

3. The apparatus of claim 2, wherein the request is an ad hoc call invite, and the processing device is configured to transmit a conference call invite to the same endpoint to which the ad hoc call invite is directed responsive to detecting the busy signal or other offline indication.

4. The apparatus of claim 1, wherein the processing device is configured to:
decode a user defined code from a call controller of the called endpoint, the user defined code originating from the called endpoint; and
cause the calendaring application to launch responsive to decoding the user defined code.

5. The apparatus of claim 1, wherein the processing device is configured to:
detect receipt of the busy signal or other offline indication at the caller endpoint; and
cause the calendaring application to launch responsive to detecting the receipt of the busy signal or other offline indication at the caller endpoint.

6. The apparatus of claim 1, wherein the processing device is configured to:
receive a message from a call controller; and
cause the calendaring application to launch responsive to receiving the message.

7. The apparatus of claim 1, wherein the processing device is configured to:
receive an input to schedule an event using the calendaring application;
schedule the event; and
at a time corresponding to the scheduled start time for the event, using the calendaring application, automatically trigger a call process from one endpoint of the scheduled event to another endpoint of the scheduled event.

8. The apparatus of claim 7, wherein automatically triggering the call process further comprises requesting user confirmation on the caller side for the call.

9. The apparatus of claim 7, wherein the calendaring application prevents a remote calendaring application for another participant of the scheduled event from discovering the event at least prior to automatically triggering the call.

10. The apparatus of claim 1, wherein the request is transmitted according to the Session Initiation Protocol (SIP).

11. The apparatus of claim 1, wherein the request is transmitted according to the eXtensible Messaging and Presence Protocol (XMPP)

12. A method, comprising:
transmit over a network a request for an ad hoc call between a caller endpoint and a called endpoint;
receive over the network a busy signal or other offline indication; and
cause a calendaring application accessible to the caller endpoint to launch responsive to receiving the busy signal or other offline indication.

13. The method of claim 12, wherein the processing device is configured to:
receive an input after the launch of the calendaring application; and
schedule a conference call using the calendaring application according to the received input, the conference call between the caller endpoint and the called endpoint.

14. The method of claim 13, wherein the request is an ad hoc call invite, and the processing device is configured to transmit a conference call invite to the same endpoint to which the ad hoc call invite is directed responsive to detecting the busy signal or other offline indication.

15. The method of claim 12, wherein the processing device is configured to:
decode a user defined code from a call controller of the called endpoint, the user defined code originating from the called endpoint;
cause the calendaring application to launch responsive to decoding the user defined code.

16. The method of claim 12, wherein the processing device is configured to:
detect receipt of the busy signal or other offline indication at the caller endpoint; and
cause the calendaring application to launch responsive to detecting the receipt of the busy signal or other offline indication at the caller endpoint.

17. The method of claim 12, wherein the processing device is configured to:
receive a command from a call controller; and
cause the calendaring application to launch responsive to receiving the command.

18. The method of claim 12, wherein the processing device is configured to:
receive an input to schedule an event using the calendaring application;
schedule the event; and
at a time corresponding to the scheduled start time for the event, using the calendaring application, automatically trigger a call process from one endpoint of the scheduled event to another endpoint of the scheduled event.

19. The method of claim 18, wherein automatically triggering the call process further comprises requesting user confirmation on the caller side for the call.

20. The method of claim 18, wherein the calendaring application prevents a remote calendaring application for another participant of the scheduled event from discovering the event at least prior to automatically triggering the call.
